(19) United States
(12) Patent Application Publication
(10) Pub. No.: US 2025/0169482 A1
(43) Pub. Date: May 29, 2025

(54) LURE STORAGE TRAY FOR A STORAGE BOX

(71) Applicant: Rapala VMC Oyj, Helsinki (FI)

(72) Inventor: Meng Da Liu, Inver Grove Heights, MN (US)

(21) Appl. No.: 18/521,118

(22) Filed: Nov. 28, 2023

(51) Int. Cl. A01K 97/06; B65D 1/34; B65D 25/06; B65D 43/16

(52) U.S. Cl. CPC A01K 97/06; B65D 1/34; B65D 25/06; B65D 43/165; B65D 2543/00194

(57) ABSTRACT

Lure storage trays and storage boxes are provided. A lure storage tray includes a tray body having a plurality of walls that define a cavity. The tray body includes a rack that extends from at least one wall of the plurality of walls within the cavity. The lure storage tray further includes a divider that is pivotably and removably coupled the rack. The divider is movable between a first position and a second position.

### FIELD

The present disclosure relates generally to a lure storage tray for a storage box. More specifically, the present disclosure relates to a lure storage tray being configured for the storage of crankbait.

### BACKGROUND

Storage boxes (e.g., tackle boxes) are utilized by anglers for storing their fishing lures and keeping them organized. Storage boxes typically feature multiple compartments and dividers, allowing anglers to categorize and separate different types and sizes of lures, which helps prevent tangling while maintaining organization and accessibility. However, problems exist with the design of many known storage boxes. For example, fishing lures have a variety of specialized sizes, shapes, and geometries that make them suitable for use in different fishing environments. Without proper storage structures for these specialized lures, the lures being stored inefficiently, resulting in wasted space and possible disorganization. Accordingly, an improved storage box, having trays with specialized storage structures that are useful for accommodating specialized lures, is desired and would be appreciated and useful.

### BRIEF DESCRIPTION

Aspects and advantages of the lure storage trays and storage boxes in accordance with the present disclosure will be set forth in part in the following description, or may be obvious from the description, or may be learned through practice of the technology.

In accordance with one embodiment, a lure storage tray is provided. The lure storage tray includes a tray body having a plurality of walls that define a cavity. The tray body includes a rack that extends from at least one wall of the plurality of walls within the cavity. The lure storage tray further includes a divider that is pivotably and removably coupled the rack. The divider is movable between a first position and a second position.

In accordance with another embodiment, a storage box is provided. The storage box includes container defines an interior. The storage box further includes a lid that is coupled to the container. The storage box further includes a lure storage tray that is coupled to the container within the interior. The lure storage tray includes a tray body having a plurality of walls that define a cavity. The tray body includes a rack that extends from at least one wall of the plurality of walls within the cavity. The lure storage tray further includes a divider that is pivotably and removably coupled the rack. The divider is movable between a first position and a second position.

These and other features, aspects and advantages of the present lure storage trays and storage boxes will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present lure storage trays and storage boxes, including the best mode of making and using the present systems and methods, directed to one of ordinary skill in the art, is set forth in the specification, which makes reference to the appended figures, in which:

FIG. 1 is a perspective view of a plurality of storage boxes stacked together in accordance with various aspects of the present disclosure;

FIG. 2 illustrates a top perspective view of a storage box in a closed position in accordance with embodiments of the present disclosure;

FIG. 3 illustrates a bottom perspective view of a storage box in a closed position in accordance with embodiments of the present disclosure;

FIG. 4 illustrates a top perspective view of a storage box in an open position in accordance with embodiments of the present disclosure;

FIG. 5 illustrates a top perspective view of a storage box in an open position, in which a plurality of trays are disposed therein, in accordance with embodiments of the present disclosure;

FIG. 6 illustrates a top-down planar view of a lure storage tray without any bait positioned therein in accordance with embodiments of the present disclosure;

FIG. 7 illustrates a top-down planar view of a lure storage tray having a first type of crankbait positioned therein in accordance with embodiments of the present disclosure;

FIG. 8 illustrates a top-down planar view of a lure storage tray having a second type of crankbait positioned therein in accordance with embodiments of the present disclosure;

FIG. 9 illustrates a perspective, partially exploded, view of a lure storage tray in accordance with embodiments of the present disclosure;

FIG. 10 illustrates an enlarged top-down planar view of a lure storage tray in accordance with various aspects of the present disclosure;

FIG. 11 an enlarged view of the encircled detail shown in FIG. 10 is illustrated in accordance with various exemplary aspects of the present disclosure;

FIG. 12 illustrates a perspective view of a divider in accordance with various aspects of the present disclosure; and

FIG. 13 illustrates a bottom-up planar view of a divider in accordance with various aspects of the present disclosure.

### DETAILED DESCRIPTION

Reference now will be made in detail to embodiments of the present lure storage tray and storage box, one or more examples of which are illustrated in the drawings. Each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The detailed description uses numerical and letter designations to refer to features in the drawings. Like or similar designations in the drawings and description have been used to refer to like or similar parts of the invention. As used herein, the terms “first”, “second”, and “third” may be used interchangeably to distinguish one component from another and are not intended to signify location or importance of the individual components.

Terms of approximation, such as “about.” “approximately,” “generally,” and “substantially,” are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values. When used in the context of an angle or direction, such terms include within ten degrees greater or less than the stated angle or direction. For example, “generally vertical” includes directions within ten degrees of vertical in any direction, e.g., clockwise or counter-clockwise.

The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

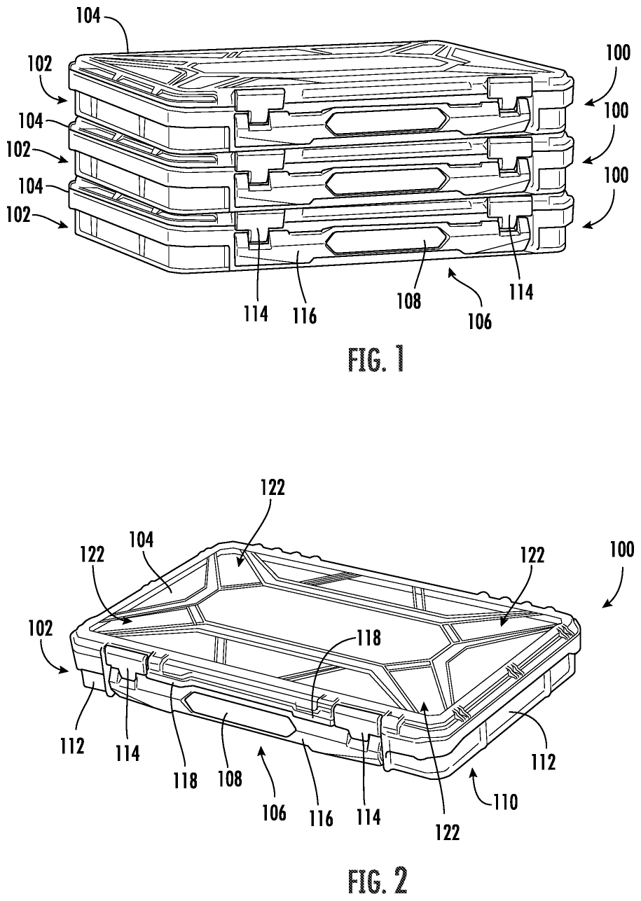

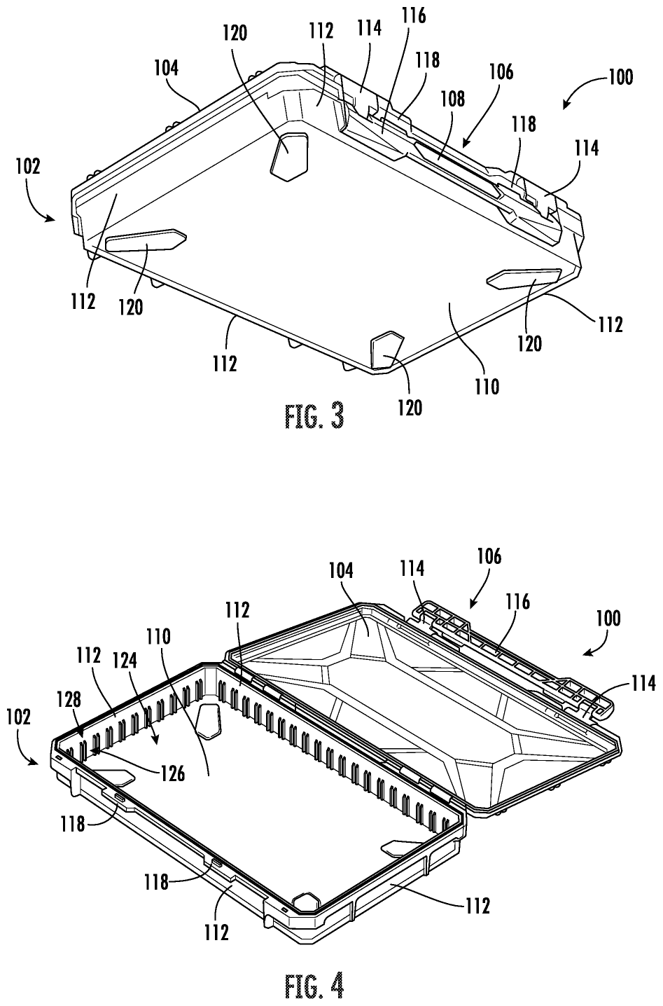

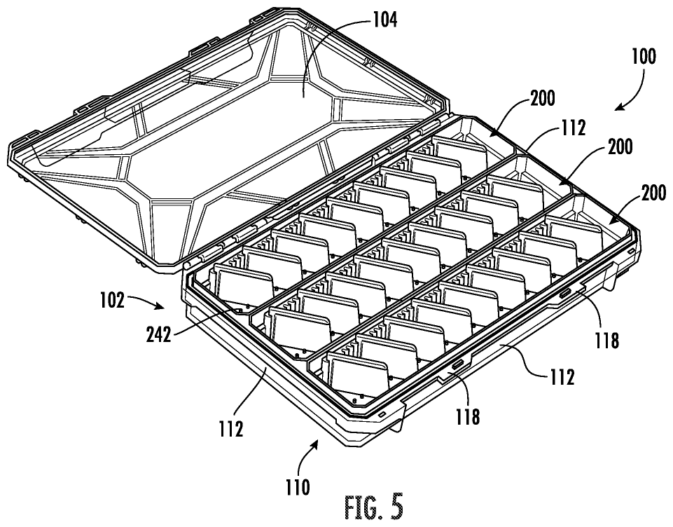

Referring now to the drawings, FIG. 1 is a perspective view of a plurality of storage boxes 100 stacked together, and FIGS. 2 through 5 illustrate various views of a single storage box 100 in accordance with embodiments of the present disclosure. Particularly, FIG. 2 illustrates a top perspective view of the storage box 100 in a closed position; FIG. 3 illustrates a bottom perspective view of the storage box 100 in a closed position; FIG. 4 illustrates a top perspective view of the storage box in an open position; and FIG. 5 illustrates another top perspective view of the storage box 100 in an open position, in which a plurality of trays 200 have been positioned therein. In exemplary embodiments, the storage box 100 may be sized and configured as a tackle box for the storage of fishing equipment, tools, lures, hooks, etc.

As shown in FIGS. 1 through 5, the storage box 100 may include a container 102 and a lid coupled to the container 102. The lid 104 may be movable relative to the container 102 between an open position and a closed position. Each storage box 100 may further include a latch assembly 106 that is coupled to the lid 104. The latch assembly 106 may include one or more hinges 114 coupled to the lid 104 and a handle 116 rotatably coupled to the one or more hinges 114, such that the handle 116 is rotatable relative to the lid 104. When in a closed position, the handle 116 may be positioned under one or more protrusions 118 extending from the container 102, such that the lid 104 remains closed unless a force is applied to the handle 116 to move the lid 104 such that the storage box 100 is in the open position. Additionally, the handle 116 may include a re-writable label 108, which may be marked by the user (e.g., using a writing utensil such as a marker) to indicate what is stored within the storage box 100. Serving as a few non-limiting examples, as shown, the re-writable label 108 may be marked “VMC RedLine,” “CrushCity,” or “Jerkbait” to indicate the contents stored within each of the storage boxes 100.

The container 102 may include a base 110 and four boundary walls 112 extending generally perpendicularly from the base 110. As shown in FIG. 3, the base 110 of the container 102 may include one or more feet 120 protruding from the base 110. The feet 120 may be formed from a rubber material or other high friction material such that the storage box 100 does not slip or slide when positioned on a surface (such as a wet surface of a boat or other environments). As shown in FIG. 2, the lid 104 may define one or more recesses 122 corresponding in number, size, shape, and location to the feet 120 on the base 110.

As shown in FIGS. 4 and 5, the container 102 (e.g., the base 110 and the boundary walls 112) may define an interior 124. When in the closed position (FIG. 2), the lid 104 may couple to the boundary walls 112 to enclose the interior 124 such that the contents of the interior 124 are encapsulated and cannot be accessed. By contrast, in the open position, lid 104 may be partially decoupled from the boundary walls 112 such that the interior 124 may be accessed.

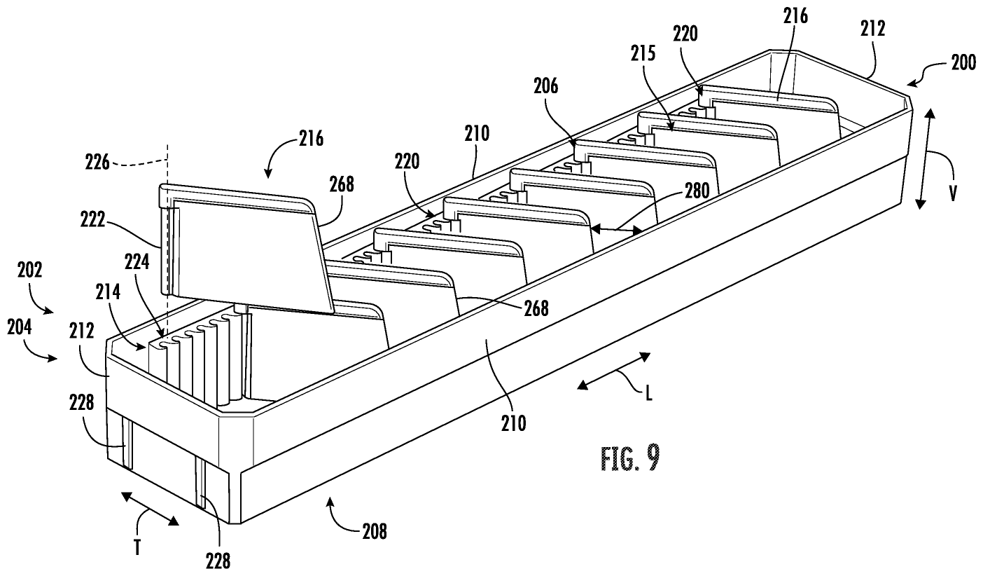

FIG. 4 illustrates the interior 124 of the container 102 without having any trays positioned therein, such that the details of the container may be better illustrated. As shown in FIG. 4, the boundary walls 112 may include a plurality of dovetail flanges 126 extending from a respective boundary wall 112 and into the interior 124. Each of the dovetail flanges 126 may define a dovetail slot 128, into which a dovetail 228 (FIG. 9) of a lure storage tray 200 may be inserted to couple the tray 200 to the container 102. As shown in FIG. 5, a plurality of lure storage trays 200 may be positioned within the interior 124 of the container 102 adjacent to one another. The plurality of lure storage trays 200 may each be removably coupled to the container 102 within the interior 124, e.g., via the dovetail joint formed between the dovetail slot 128 of the container 102 and the dovetail 228 of the lure storage tray 200 (FIG. 9). Alternatively, or additionally, one or more lure storage trays 200 may be fixedly coupled to the container 102 (or integrally formed with the container).

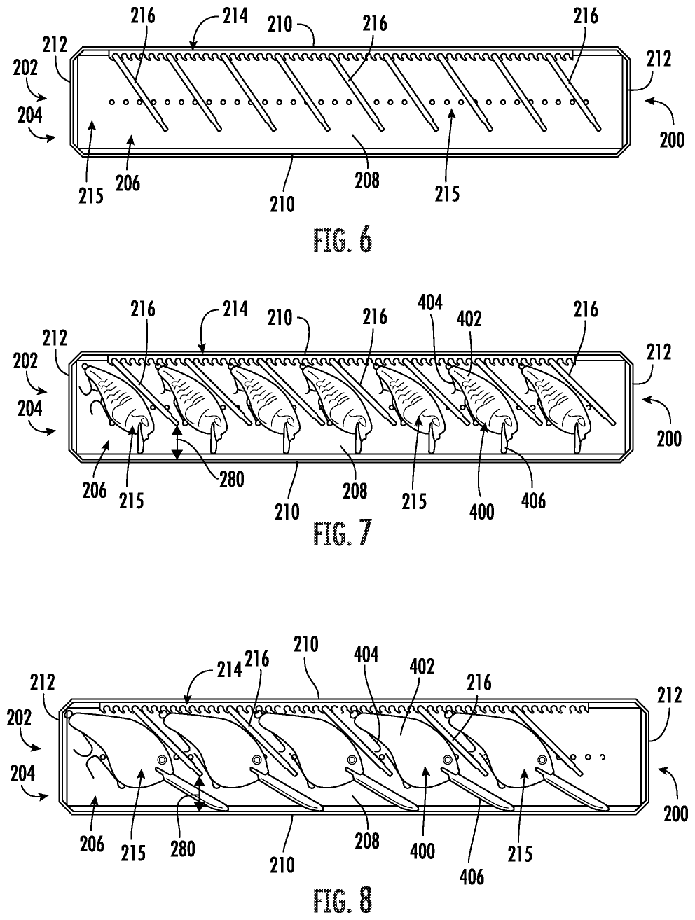

Referring now to FIGS. 6, 7, and 8, each figure illustrates a top down view of a lure storage tray 200 in accordance with embodiments of the present disclosure. As will be discussed below in more detail, the lure storage tray 200 may include a tray body 202 having a plurality of walls 204 (e.g., a base wall 208, side walls 210, and end walls 212) that define a cavity 206. Additionally, a rack 214 may extend from at least one wall of the plurality of walls 204 within the cavity 206. A plurality of dividers 216 may be pivotably and removably coupled to the rack 214. Particularly, each of the dividers 216 may be removed, rearranged, and rotated about the rack 214 to adjust the size, spacing, and number of bait compartments 215 within the cavity 206. That is, the dividers 216 may partition the cavity 206 into two or more bait compartments 215 into which fishing bait may be inserted and stored. The bait compartments 215 may be defined between two dividers 216 and/or between a divider 216 and one or more of the walls of the plurality of walls 204.

Particularly, as shown in FIGS. 7 and 8, the lure storage tray 200 may be advantageously configured for the storage of crankbait 400 within each of the bait compartments 215. Crankbait 400 is a type of fishing lure that is designed to imitate the swimming motion of prey fish. The crankbait 400 includes a bait body 402 extending between a nose and a tail, one or more hooks 404 extending from the bait body 402 (e.g., between the nose and the tail), and a diving lip 406 extending from the nose of the bait body 402. The diving lip 406 may allow the crankbait 400 to dive to a certain depth when retrieved through the water. As should be appreciated, the diving lip 406 of the crankbait 400 has traditionally made storage of such bait difficult. As will be discussed below in further detail, the present lure storage tray 200 having removable and pivotable dividers advantageously allows for storage of most commercially available crankbaits.

Referring now to FIG. 9, a perspective, partially exploded, view of a single lure storage tray 200 is illustrated in accordance with embodiments of the present disclosure. As shown, the lure storage tray 200 may define a cartesian coordinate system having a vertical direction V, a longitudinal direction L, and a transverse direction T mutually perpendicular to one another. The lure storage tray 200 may be generally shaped as a rectangular prism having one open side.

As shown in FIG. 9, the lure storage tray 200 may include the tray body 202 having the plurality of walls 204 that define the cavity 206. Particularly, the plurality of walls 204 may include a base wall 208, side walls 210 extending from the base wall 208, and end walls 212 extending from the base wall 208 between the side walls 210. The side walls 210 may be spaced apart from one another and extend between the end walls 212. Similarly, the end walls may be spaced apart from one another and extend between the side walls 210. The base wall 208 may be generally planar and may extend in the longitudinal direction L and the transverse direction T between the side walls 210 and the end walls 212. The side walls 210 may extend generally perpendicularly from the base wall 208 and between the end walls 212 (e.g., generally vertically and longitudinally). The end walls 212 may extend generally perpendicularly from the base wall 208 and between the side walls 210 (e.g., generally vertically and transversely).

As shown in FIG. 9, the rack 214 may extend from a side wall 212 (e.g., a first side wall) of the side walls 212 within the cavity 206. Additionally, a plurality of dividers 216 may each be pivotably and removably coupled to the rack 214. The plurality of dividers 216 may extend from the rack 214 on the first side wall 212, within the cavity 206, and may be spaced apart from the second side wall 212. A pivot joint 220 may be defined between (e.g., at the junction between) the rack 214 and each of the dividers 216, such that each divider 216 is rotatable about the pivot joint 220. More specifically, the pivot joint 220 may include a pivot feature 222 (e.g., positive pivot feature, such as a ball or cylinder) and a pivot opening 224 (e.g., a negative pivot feature, such as a socket or slot) into which the positive pivot feature 222 may be inserted and rotate. The pivot opening may be sized and shaped to receive the pivot feature 222 and allow for rotational movement while restricting translational movement in one or more directions. In various embodiments, one of the divider 216 or the rack 214 may include the pivot feature 222 of the pivot joint 220, and the other of the divider 216 or the rack 214 may define the pivot opening 224 of the pivot joint 220. When assembled, the pivot feature 222 may be positioned within the pivot opening 224.

In exemplary embodiments, as shown, the divider 216 may include the pivot feature 222, and the rack 214 may define the pivot opening 224 into which the pivot feature 222 may be inserted. However, it should be understood that the opposite arrangement is also possible (although not shown), e.g., where the divider defines the pivot opening and the rack includes the pivot feature. The present invention should not be limited to one particular arrangement unless specifically recited in the claims.

As shown in FIG. 9, one divider 216 is exploded from the tray body 202 and decoupled from the rack 214. As shown, the rotation axis 226 may be defined along the center of the pivot feature 222 and the pivot opening 224. The rotation axis 226 may be oriented generally vertically (e.g., along the vertical direction V). Additionally, the rotation axis 226 may be the common axial centerline of the pivot feature 222 of the divider 216 and the pivot opening 224 of the rack 214. The divider 216 may be vertically movable along the rotation axis 226 to insert the pivot feature 222 of the divider 216 into the pivot opening 224 defined by the rack 214. Once inserted, the divider 216 may be rotatable (or pivotable) about the rotation axis 226 between a variety of different positions (as discussed below).

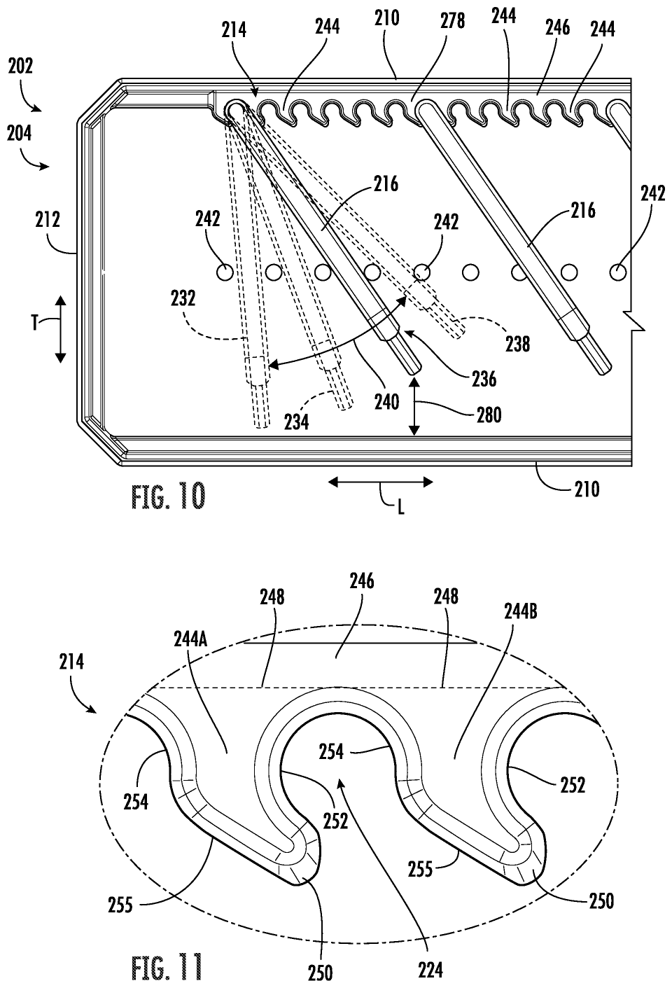

Referring now to FIG. 10, an enlarged top-down view of the lure storage tray 200 is illustrated in accordance with various aspects of the present disclosure. As shown in FIG. 10, the divider 216 may be pivotable between each of the positions shown in phantom lines, e.g., a first position 232, a second position 234, a third position 236 (in which the divider 216 is positioned in FIG. 10), and a fourth position 238. In the first position 232, the divider 216 may be generally perpendicular (e.g., within ten degrees of perpendicular) to the side wall 212. In the fourth position 238, the divider 216 may form an angle of between about 40° and 50°. In this way, the divider may have an angular range of motion 240 of about 40° and about 50° between the first position 232 and the fourth position 238.

In exemplary embodiments, as shown in FIG. 10, a plurality of protrusions 242 may extend from the base wall 208 and into the cavity 206. The plurality of protrusions 242 may be generally shaped as cylinders (although other shapes are possible, such as rectangular prisms or other shapes). The protrusions 242 may each extend generally vertically from the base wall 208 to a respective free end. The protrusions 242 may be spaced apart from one another in the longitudinal direction Land aligned in the transverse direction T (such that each of the protrusions falls along a common longitudinally extending axis). Each of the protrusions 242 may be generally centered on the base with respect to the transverse direction T. That is, each of the protrusions 242 may be generally equally spaced from the first side wall and the second side wall of the side walls 212.

As shown in FIG. 10, the divider 216 may be disposed between a first pair of protrusions of the plurality of protrusions 242 in the first position 232; the divider 216 may be disposed between a second pair of protrusions of the plurality of protrusions 242 in the second position 234; the divider 216 may be disposed between a third pair of protrusions of the plurality of protrusions 242 in the third position 236; and the divider 216 may be disposed between a fourth pair of protrusions of the plurality of protrusions 242 in the fourth position 238. Neighboring pairs of protrusions may share a common protrusion 242 (e.g., the first pair may share a common protrusion with the second pair, and so on and so forth).

In many embodiments, as shown in FIG. 10, the rack 214 includes a plurality of fingers 244 extending from the at least one wall of the plurality of walls 204 (e.g., the side wall 212). Particularly, the rack 214 may include a shank portion 246 extending from the side wall 212, and the plurality of fingers 244 may each extend from the shank portion 246.

Referring now to FIG. 11, an enlarged view of the encircled detail from FIG. 10 is illustrated in accordance with various exemplary aspects of the present disclosure. As shown in FIG. 11, each of the fingers 244A, 244B may extend generally transversely from a base 248 at an intersection between the shank portion 246 and the respective finger 244 (shown as a phantom line) to a terminal end 250. the pivot opening 224 may be defined between two neighboring fingers 244A, 244B of the plurality of fingers 244. The pivot opening 224 may be generally circularly shaped. Each of the fingers 244A, 244B may include a major curved portion 252 and a minor curved portion 254 oppositely disposed from one another. The major curved portion 252 of a first finger 244A defines a majority (e.g., more than about 50%) of the circularly shaped pivot opening 224, and the minor curved portion 254 of a second finger 244B may define a minority (e.g., less than about 50%) of the pivot opening 224. Additionally, each of the fingers 244A, 244B may include a slanted stop wall 255 extending from the minor curved portion 254 to the terminal end 250, which provides a large surface for the divider 216 to contact to prevent excessive stresses when the divider is rotatably forced against the rack 214.

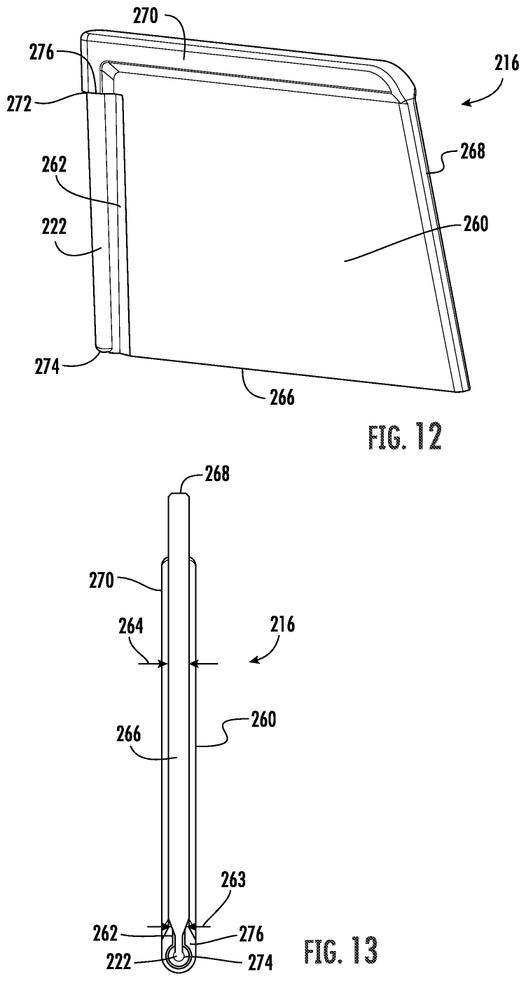

Referring now to FIGS. 12 and 13, various views of the divider 216 are illustrated in accordance with embodiments of the present disclosure. The divider 216 may be incorporated in the lure storage tray 200 and/or the storage box 100 described above with reference to FIGS. 1-11. Particularly, FIG. 12 illustrates a perspective view of a divider 216, and FIG. 13 illustrates a bottom-up planar view of the divider 216. As shown, the divider 216 may include a main body 260, a neck portion 262, a pivot feature 222, and a handle portion 270. The main body 260 may be shaped as a generally planar flat plate (e.g., having no curvatures or sudden changes in shape along the surface). The main body 260 may include a bottom edge 266 and a side edge 268 extending from the bottom edge 266. The main body 260 may generally extend between the bottom edge 266, the side edge 268, the neck portion 262, and the handle portion 270. Additionally, as shown best in FIG. 13, the main body 260 may define a generally constant width 264 from the neck portion 262 to the side edge 268.

The neck portion 262 may extend from the main body 260 to the pivot feature 222. The neck portion 262 may define a width 263 that tapers or converges (e.g., the width 263 decreases) as the neck portion 262 extends from the main body 260 to the pivot feature 222. The neck portion 262 advantageously increases the range of motion 240 (FIG. 10) by increasing the amount the divider 216 can rotate relative to the rack 214 prior to contacting one of the fingers 244.

The pivot feature 222 may extend from the neck portion 262 and between a root 272 and a tip 274. The root 272 may be disposed at an intersection between the pivot feature 222 and the handle portion 270. The pivot feature 222 may be generally frustoconically shaped and may have a circular cross-sectional shape, such that the pivot feature defines a diameter that converges (e.g., decreases) as the pivot feature 222 extends from the root 272 to the tip 274.

The handle portion 270 may extend and protrude from the main body 260, the neck portion 262, and the pivot feature 222. The handle portion 270 may define a first flat face 276 that extends generally perpendicularly from the pivot feature 222 (e.g., at an intersection between the pivot feature 222 and the handle portion 270). The first flat face 276 may contact the rack 214 when the divider 216 is coupled thereto. For example, referring back to FIG. 10 briefly, the rack 214 may include a second flat face 278 that contacts the first flat face 276 of the divider 216 when the divider 216 is inserted into the rack 214. To pivotably and removably couple a divider 216 to the rack 214, the tip 274 of the pivot feature 222 is inserted into the pivot opening 222 until the first flat face 276 of the handle portion 270 contacts the second flat face 278 of the rack 214.

As shown in FIGS. 9 and 12 collectively, the side edge 268 of the divider 216 may be angled relative to the bottom edge 266 and the handle portion 270. In other words, the side edge 268 of the divider may be slanted or sloped relative to the bottom edge 266 and the handle portion 270, and the side edge 268 may extend between the bottom edge 266 and the handle portion 270. When the divider 216 is coupled to the rack 214, bottom edge 266 may be parallel to the base wall 208, and the side edge 268 may be slanted relative to the base wall 208 and the side walls 212, such that the side edge 268 is generally oblique to the base wall 208 and the side walls 212 (e.g., the side edge 268 is angled relative to each of the vertical direction V, the longitudinal direction L, and the transverse direction T). Additionally, as shown in FIGS. 9 and 10, when the divider 216 is coupled to the rack 214, the side edge 268 may be spaced apart a side wall 212 (regardless of the pivoted position of the divider 216), such that a gap 280 is defined therebetween (e.g., between the side wall 212 and the side edge 268. As shown best in FIG. 9, the side edge 268 may be slanted relative to the at least one wall of the plurality of walls 204 (e.g., relative to the side wall 212) such that the gap 280 varies in width from along the side edge 268. This advantageously allows the diving lip 406 of the crankbait 400 (see FIGS. 7 and 8) to extend through the gap 280 without creating excessive room at the base wall 208 (where the gap 280 is the smallest) for the diving lip 406 to move/shift position.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

Further aspects of the invention are provided by the subject matter of the following clauses:

A lure storage tray comprising: a tray body having a plurality of walls that define a cavity, the tray body including a rack that extends from at least one wall of the plurality of walls within the cavity; and a divider pivotably and removably coupled to the rack, the divider movable between a first position and a second position.

The lure storage tray as in any preceding clause, wherein the divider and the rack form a pivot joint about which the divider may rotate relative to the rack.

The lure storage tray as in any preceding clause, wherein one of the divider or the rack include a pivot feature of the pivot joint, wherein the other of the divider or the rack define a pivot opening of the pivot joint, and wherein the pivot opening is sized and shaped to receive the pivot feature.

The lure storage tray as in any preceding clause, wherein the divider includes an edge spaced apart from at least one wall of the plurality of walls such that a gap is defined therebetween.

The lure storage tray as in any preceding clause, wherein the edge is slanted relative to the at least one wall of the plurality of walls such that the gap varies in width from along the edge.

The lure storage tray as in any preceding clause, wherein the plurality of walls include a base wall, side walls extending generally perpendicularly from the base wall, and end walls extending generally perpendicularly from the base wall and between the side walls, wherein the rack extends from a side wall of the side walls.

The lure storage tray as in any preceding clause, wherein a plurality of protrusions extend from the base wall and into the cavity, the plurality of protrusions being spaced apart from one another.

The lure storage tray as in any preceding clause, wherein the divider is disposed between a first pair of protrusions of the plurality of protrusions in the first positions, and wherein the divider is disposed between a second pair of protrusions of the plurality of protrusions in the second position.

The lure storage tray as in any preceding clause, wherein the divider includes a main body, a neck portion extending from the main body, and a pivot feature extending from the neck portion.

The lure storage tray as in any preceding clause, wherein the rack includes a plurality of fingers extending from the at least one wall of the plurality of walls, wherein a pivot opening is defined between two neighboring fingers of the plurality of fingers, and wherein the pivot feature of the divider is positioned within the pivot opening.

A storage box comprising: a container defining an interior; a lid coupled to the container; a lure storage tray coupled to the container within the interior, the lure storage tray comprising: a tray body having a plurality of walls that define a cavity, the tray body including a rack that extends from at least one wall of the plurality of walls within the cavity; and a divider pivotably and removably coupled to the rack, the divider movable between a first position and a second position.

The storage box as in any preceding clause, wherein the divider and the rack form a pivot joint about which the divider may rotate relative to the rack.

The storage box as in any preceding clause, wherein one of the divider or the rack include a pivot feature of the pivot joint, wherein the other of the divider or the rack define a pivot opening of the pivot joint, and wherein the pivot opening is sized and shaped to receive the pivot feature.

The storage box as in any preceding clause, wherein the divider includes an edge spaced apart from at least one wall of the plurality of walls such that a gap is defined therebetween.

The storage box as in any preceding clause, wherein the edge is slanted relative to the at least one wall of the plurality of walls such that the gap varies in width from along the edge.

The storage box as in any preceding clause, wherein the plurality of walls include a base wall, side walls extending generally perpendicularly from the base wall, and end walls extending generally perpendicularly from the base wall and between the side walls, wherein the rack extends from a side wall of the side walls.

The storage box as in any preceding clause, wherein a plurality of protrusions extend from the base wall and into the cavity, the plurality of protrusions being spaced apart from one another.

The storage box as in any preceding clause, wherein the divider is disposed between a first pair of protrusions of the plurality of protrusions in the first positions, and wherein the divider is disposed between a second pair of protrusions of the plurality of protrusions in the second position.

The storage box as in any preceding clause, wherein the divider includes a main body, a neck portion extending from the main body, and a pivot feature extending from the neck portion.

The storage box as in any preceding clause, wherein the rack includes a plurality of fingers extending from the at least one wall of the plurality of walls, wherein a pivot opening is defined between two neighboring fingers of the plurality of fingers, and wherein the pivot feature of the divider is positioned within the pivot opening.

What is claimed is:

1. A lure storage tray comprising:
a tray body having a plurality of walls that define a cavity, the tray body including a rack that extends from at least one wall of the plurality of walls within the cavity; and
a divider pivotably and removably coupled to the rack, the divider movable between a first position and a second position.

2. The lure storage tray as in claim 1, wherein the divider and the rack form a pivot joint about which the divider may rotate relative to the rack.

3. The lure storage tray as in claim 2, wherein one of the divider or the rack include a pivot feature of the pivot joint, wherein the other of the divider or the rack define a pivot opening of the pivot joint, and wherein the pivot opening is sized and shaped to receive the pivot feature.

4. The lure storage tray as in claim 1, wherein the divider includes an edge spaced apart from at least one wall of the plurality of walls such that a gap is defined therebetween.

5. The lure storage tray as in claim 4, wherein the edge is slanted relative to the at least one wall of the plurality of walls such that the gap varies in width from along the edge.

6. The lure storage tray as in claim 1, wherein the plurality of walls include a base wall, side walls extending generally perpendicularly from the base wall, and end walls extending generally perpendicularly from the base wall and between the side walls, wherein the rack extends from a side wall of the side walls.

7. The lure storage tray as in claim 6, wherein a plurality of protrusions extend from the base wall and into the cavity, the plurality of protrusions being spaced apart from one another.

8. The lure storage tray as in claim 7, wherein the divider is disposed between a first pair of protrusions of the plurality of protrusions in the first positions, and wherein the divider is disposed between a second pair of protrusions of the plurality of protrusions in the second position.

9. The lure storage tray as in claim 1, wherein the divider includes a main body, a neck portion extending from the main body, and a pivot feature extending from the neck portion.

10. The lure storage tray as in claim 9, wherein the rack includes a plurality of fingers extending from the at least one wall of the plurality of walls, wherein a pivot opening is defined between two neighboring fingers of the plurality of fingers, and wherein the pivot feature of the divider is positioned within the pivot opening.

11. A storage box comprising:
a container defining an interior;
a lid coupled to the container;
a lure storage tray coupled to the container within the interior, the lure storage tray comprising:
a tray body having a plurality of walls that define a cavity, the tray body including a rack that extends from at least one wall of the plurality of walls within the cavity; and
a divider pivotably and removably coupled to the rack, the divider movable between a first position and a second position.

12. The storage box as in claim 11, wherein the divider and the rack form a pivot joint about which the divider may rotate relative to the rack.

13. The storage box as in claim 12, wherein one of the divider or the rack include a pivot feature of the pivot joint, wherein the other of the divider or the rack define a pivot opening of the pivot joint, and wherein the pivot opening is sized and shaped to receive the pivot feature.

14. The storage box as in claim 11, wherein the divider includes an edge spaced apart from at least one wall of the plurality of walls such that a gap is defined therebetween.

15. The storage box as in claim 14, wherein the edge is slanted relative to the at least one wall of the plurality of walls such that the gap varies in width from along the edge.

16. The storage box as in claim 11, wherein the plurality of walls include a base wall, side walls extending generally perpendicularly from the base wall, and end walls extending generally perpendicularly from the base wall and between the side walls, wherein the rack extends from a side wall of the side walls.

17. The storage box as in claim 16, wherein a plurality of protrusions extend from the base wall and into the cavity, the plurality of protrusions being spaced apart from one another.

18. The storage box as in claim 17, wherein the divider is disposed between a first pair of protrusions of the plurality of protrusions in the first positions, and wherein the divider is disposed between a second pair of protrusions of the plurality of protrusions in the second position.

19. The storage box as in claim 11, wherein the divider includes a main body, a neck portion extending from the main body, and a pivot feature extending from the neck portion.

20. The storage box as in claim 19, wherein the rack includes a plurality of fingers extending from the at least one wall of the plurality of walls, wherein a pivot opening is defined between two neighboring fingers of the plurality of fingers, and wherein the pivot feature of the divider is positioned within the pivot opening.
